(19) United States
(12) Patent Application Publication
(10) Pub. No.: US 2026/0277730 A1
(43) Pub. Date: Sep. 17, 2026

(54) AI SELF-DIAGNOSTICS FOR CONSUMER ELECTRONICS DEVICES

(71) Applicant: Sony Group Corporation, TOKYO (JP)

(72) Inventors: James R. Milne, San Diego, CA (US); Justin Kenefick, San Diego, CA (US); William Clay, San Diego, CA (US); Christopher Bjork, San Diego, CA (US)

(21) Appl. No.: 19/079,944

(22) Filed: Mar. 14, 2025

(51) Int. Cl. G06F 11/07; H04L 41/5074

(52) U.S. Cl. CPC G06F 11/0793; G06F 11/0769; H04L 41/5074

(57) ABSTRACT

In one example, a client device may include a processor system and storage accessible to the processor system. The storage may include instructions executable by the processor system to, responsive to a trigger, execute one or more self-diagnostic algorithms at the client device to assess one or more aspects of the client device. The instructions may also be executable to, based on execution of the one or more self-diagnostic algorithms, generate a report indicating one or more results of the one or more self-diagnostic algorithms. The instructions may then be executable to communicate with a server to provide the report to the server and to determine one or more corrective actions to be performed at the client device to address an issue indicated in the report. The instructions may be further executable to perform the one or more corrective actions at the client device to address the issue.

### FIELD

The disclosure below relates to technically inventive, non-routine solutions that are necessarily rooted in computer technology and that produce concrete technical improvements. In particular, the disclosure below relates to artificial intelligence (AI)-based self-diagnostics and remedial measures for consumer electronics devices.

### BACKGROUND

As recognized herein, malfunctioning consumer electronics devices can be very frustrating and difficult to figure out. The disclosure below further recognizes that current reactive solutions are either inadequate or take too long, and that proactive device-based solutions can provide considerable technological improvements.

### SUMMARY

Accordingly, in one aspect an apparatus includes a processor system and storage accessible to the processor system. The storage includes instructions executable by the processor system to, responsive to a trigger, execute one or more self-diagnostic algorithms at a second client device to assess one or more aspects of the second client device. The instructions are also executable to, based on execution of the one or more self-diagnostic algorithms, generate a report indicating one or more results of the one or more self-diagnostic algorithms. The instructions are further executable to communicate with a server to provide the report to the server and to determine one or more corrective actions to be performed at the second client device to address an issue indicated in the report. From there, the instructions are executable to perform the one or more corrective actions to address the issue.

In one example embodiment, the instructions may be executable to, as part of execution of the one or more self-diagnostic algorithms, execute a large language model (LLM) to analyze code stored at the second client device to identify one or more errors in the code. The instructions may then be executable to indicate the one or more identified errors in the report. In certain instances, the code may include firmware code.

Also in example embodiments, the instructions may be executable to, responsive to firmware being updated at the second client device, execute a large language model (LLM) to write the one or more self-diagnostic algorithms to analyze the updated firmware for identification of one or more errors in the updated firmware. The instructions may then be executable to execute the one or more self-diagnostic algorithms written by the LLM to analyze the updated firmware for identification of one or more errors in the updated firmware. The instructions may also be executable to indicate, in the report, a first error identified via the execution of the one or more self-diagnostic algorithms written by the LLM.

What's more, in some implementations the one or more corrective actions may be one or more first corrective actions. Here the instructions may be executable to, as part of execution of the one or more self-diagnostic algorithms, execute a machine learning (ML) model at the second client device to assess one or more aspects of the second client device and to identity, based on the assessment, one or more second corrective actions to be performed at the second client device. The instructions may also be executable, according to this implementation, to perform the one or more second corrective actions at the second client device without receiving input from the server instigating performance of the one or more second corrective actions.

What's more, in some non-limiting examples the instructions may be executable to communicate with the server to create an electronic technical support ticket for a technician to use to help address the issue. And in some case, it may be desirable to inform a design team member(s) (hardware and/or software).

In addition, the one or more corrective actions themselves may be autonomously performed by the second client device, and/or may be performed in conjunction with user input to assist in the one or more corrective actions.

In some embodiments, the second client device may be the first client device. Thus, the instructions may be executable to, responsive to an Internet connection being currently-active at the first device, use the currently-active Internet connection to provide the report to the server. Here the instructions may also be executable to, responsive to no currently-active Internet connection at the first device, communicate with a third client device to provide the report to the server via the third client device. The third client device may be different from the first client device.

However, in other embodiments, the second client device may be different from the first client device. According to these embodiments, the instructions may be executable to route communications from the second client device to the server through the first client device to provide the report via a currently-active Internet connection at the first client device. In some instances, the instructions may be further executable to establish a virtual private network (VPN) at the first client device, and to use the VPN to route the communications from the second client device to the server.

In terms of the issue itself, the issue may relate to wireless communication, hardware device functionality, and/or software execution. The trigger may include power-on of the second client device, a new power cycle of the second client device, a recurring period of time transpiring, and/or a software update being performed at the second client device.

In another aspect, a method includes executing one or more diagnostic algorithms at a client device to assess one or more aspects of the client device. Based on executing the one or more diagnostic algorithms at the client device, the method then includes executing an artificial intelligence (AI) model to address an issue identified via the one or more diagnostic algorithms, and/or generating a report indicating the issue and sending the report to a support center for assistance in addressing the issue identified via the one or more diagnostic algorithms.

In still another aspect, an apparatus includes at least one computer readable storage medium (CRSM) that is not a transitory signal. The at least one CRSM includes instructions executable by a processor system to execute one or more diagnostic algorithms at a client device to assess one or more aspects of the client device. Based on execution of the one or more diagnostic algorithms at the client device, the instructions are executable to execute a model locally at the client device to address an issue identified via the one or more diagnostic algorithms, and/or to generate a report indicating the issue and to send the report to a server for artificial intelligence-based assistance via the server to address the issue.

In some implementations, the instructions may be executable to, based on execution of the one or more diagnostic algorithms at the client device, execute the model locally at the client device to address the issue.

Also in some implementations, the instructions may be executable to, based on execution of the one or more diagnostic algorithms at the client device, generate the report indicating the issue and send the report to the server for artificial intelligence-based assistance via the server to address the issue. Here the instructions may also be executable to communicate with the server, in response to sending the report, to address the issue.

The details of the present disclosure, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example computing system consistent with present principles;

FIGS. 2 and 3 show example graphical user interfaces (GUIs) for setting client device permissions related to execution of self-diagnostics at the client device consistent with present principles;

FIG. 4 shows a GUI for an end-user to command a client device to use AI to discover the capabilities of a hearable client device consistent with present principles;

FIG. 5 shows an example GUI that presents an error message at a client device consistent with present principles;

FIG. 6 shows an example GUI that may be presented at a client device responsive to execution of a self-diagnostic algorithm that has identified one or more issues consistent with present principles;

FIG. 7 shows an example GUI indicating a firmware update is available to address an issue identified by a self-diagnostic algorithm consistent with present principles;

FIGS. 8 and 9 show example GUIs that may be presented for an end-user to command a client device to send a self-diagnostic report to a support center and to create a support ticket with the support center consistent with present principles;

FIG. 10 shows another example GUI confirming that a support ticket has been created consistent with present principles;

FIGS. 11 and 12 show example GUIs that may be presented at a support center device to allow a support technician to assist an end-user with an issue with the end-user's client device consistent with present principles;

FIG. 13 shows an example GUI presentable at a support center device, with the GUI including a Pareto chart of trends related to issues identified by self-diagnostics run at client devices and including interactive elements for addressing the issues consistent with present principles;

FIG. 14 shows an example GUI that may be presented at a support center device to provide a firmware update to client devices experiencing issues identified via self-diagnostics executed at those client devices consistent with present principles;

FIG. 15 shows example logic in flow chart format that may be executed by a client device processor system consistent with present principles;

FIG. 16 shows example logic in flow chart format that may be executed by a support center device processor system consistent with present principles;

FIG. 17 shows example artificial intelligence (AI) architecture that may be implemented at a client device and/or support center device consistent with present principles; and

FIG. 18 is a schematic diagram of an example overall system consistent with present principles.

### DETAILED DESCRIPTION

### Client Device-Related Aspects

As a non-limiting overview and consistent with additional details provided below, it is to be understood that the ability of a client device to run self-diagnostics can be important because the device may be able to supply more-detailed information to the user and a support center. As described in greater detail below, the user can also supplement the diagnostic information by supplying use case scenarios when trouble occurs. Once a diagnostic is run and a problem is detected, then the hearable or other client device can connect to the Internet via a smart device and contact the manufacturer's support center to create an automatic ticket. The logging of the ticket may cause a notice for the user to be contacted as soon as possible via a preferred method (e.g., email, text, call, etc.). That way the user does not need to call and wait on hold for an unknown time.

In addition, logs and reports can be sent to the support center and stored for long-term analytics. Thus, diagnostic data may be sent to the support center regardless of whether an auto ticket is or is not issued. The diagnostic data may be stored at the support center to be reviewed periodically for trends.

What's more, if the client device experiencing the issue has Internet capability itself, then that device can send a message directly to the support center. If the client device does not have Internet capability, it can wirelessly connect to another smart device that does have Internet capability and communicate through the other client device to request the message be forwarded to the service center. Wireless communication may occur over a Wi-Fi connection, a Bluetooth connection (e.g., a Bluetooth Low Energy connection specifically), an ultrawideband (UWB) connection, or other wireless connection.

In one particular example, artificial intelligence (AI) modeling may be done at the design level so that the AI can learn about all the various client device interfaces the AI will need to know. Those interfaces may include, but are not limited to, interfaces for Wi-Fi, Bluetooth, universal serial bus (USB), ethernet, cameras, other sensors (such as presence, light, infrared, and motion sensors), graphics (e.g., graphics cards and graphics processing units), and memory (e.g., RAM).

The client device's local AI model may therefore know how to test each on-board technology (e.g., is preprogrammed to do so). Additionally or alternatively, the AI model may learn how to test when a new feature is added or enabled locally at the client device.

In some specific non-limiting examples, a single AI may be developed for all products/client devices. The AI may be programmed to know all the types of peripherals with which to interface and know as many use cases as possible (e.g., how the user will use the client device(s)). And the AI may be configured to know how multiple client devices can and will work together (e.g., via wireless communication to execute a given function like playing audio at a hearable device as streamed from a smartphone).

What's more, the client device's AI may communicate with a support center via an Internet connection. In one particular embodiment, during initial client device setup (e.g., initialization) the user may be asked for permission to send diagnostics/logs/history to the support center. The user may then allow or not allow that action. If the user does not allow the action, the user can change the permission setting(s) later via a menu selection. If the user does allow the action, the user can pick how frequently to send data to support center, even when no problem exists (and thus data can be sent that the client device is functioning without issue).

According to one example, a hearable device and another smart client device (e.g., smartphone, tablet, smart glasses, etc.) may connect to each other. The AI stored and executing at the hearable device may discover on-board technologies of the hearable device automatically and/or by user command. The AI may then create a diagnostic test plan and subsequently run the diagnostic test plan. The AI may then create a test report. In addition, the AI may display results on the display of the client device, and/or email or text the report/results to the support center. Once received by the support center device, the support center device may create an automatic ticket to contact the user (e.g., by phone, text, email, chat, etc.).

As another example, hearable AI (HAI) on a hearable client device may discover on-board technologies during each power cycle or by user command. New technologies may be checked responsive to each power cycle since features may change when a new firmware update is installed (and hence a restart is performed as part of the firmware update). The HAI may therefore create a diagnostic test plan, run the diagnostic plan it creates, and then display the results/outcome of that diagnostic test plan. The HAI can then connect to the paired smart device to email and/or text the report to the support center, if desired. The text may be an Internet-based text message, a short message service (SMS) text message, a multimedia messaging service (MMS) text message, or another type of text message. Once received by the support center device, the support center device may create an automatic ticket to contact the user (e.g., via phone, text, email, chat, etc.)

As yet another example that may be used alone or in combination with others, diagnostics may be run at a client device in the background without prompting by the user. Reports from the diagnostics may then be displayed when requested (e.g., by the user or support technician), and/or when a problem arises. The support center may then create an automatic ticket to contact the user (via phone, text, email, chat, etc.) once the report is received.

As still another example, the client device host or AI may have the following capabilities. First, it may discover on-board hardware capabilities, including those related to Wi-Fi transceivers, Bluetooth transceivers, various sensors like accelerometers and gyroscopes, camera and picture enhancement hardware, etc. The local AI may also know when new hardware features are added or enabled. In addition, the AI may discover on-board software capabilities, including hearing protection, hearing enhancement, active noise canceling, etc. The AI can also be configured to know when new software features have been added or enabled. Also according to this example, the AI may discover remote hardware capabilities (e.g., searching for an external Internet-capable device and/or an external camera) as well as remote software capabilities (e.g., searching for virtual private network (VPN) capabilities). All of these types of discoveries may happen when an interface's hardware and/or software configuration registers are read to identify those things from the registers themselves.

As an example of a hearable wireless connection diagnostic, the diagnostic might execute the following algorithm and functions. First, the diagnostic may check to see if there is a wireless module present (e.g., by reading the config register). This might include checking for Bluetooth and Wi-Fi modules (e.g., in the registers). Next the diagnostic may check to see if the wireless module is enabled (again in the register), then check to see if the hearable device is paired to another smart device (e.g., via Bluetooth). The diagnostic may then check to see if the hearable device is connected to the smart device's app for the hearable (e.g., again via Bluetooth). The diagnostic may then check to see if the hearable device has an Internet connection. If there is no Wi-Fi or other Internet connection, the diagnostic can request the Bluetooth-connected app on the other client device to make an Internet connection via that other smart device. The diagnostic may also check to see if there is wireless module connected to an access point (e.g., Wi-Fi access point) and/or if the wireless module is connected to the Internet (e.g., via Wi-Fi). Next the diagnostic may check to see if it can wireless module ping a server (e.g., over Wi-Fi). Based on the result of those inquiries, the diagnostic may create a diagnostic report to send to the support center's computer. If a currently-active Internet connection is not available, the hearable can store the diagnostic report until Internet is available (and transmit the report responsive to the Internet becoming available). Additionally or alternatively, the hearable or connected device may ask the user if they want to send the diagnostic results to the support center via the connected device.

An example of a hearable error message will now be discussed. In one instance, an error message may be displayed on the paired smart device through its Bluetooth-connected application (“app”), and/or the error message may be verbally announced at either or both devices (e.g., using a LLM to generate the natural language that then gets converted to audio by a digital assistant's text-to-speech module). The hearable device may also ask the user if they want to report the error message to the support center, ask the user if they want to reset device, and/or ask the user if they want to run diagnostics and report the results to the support center.

Thus, innovative aspects for the client devices as discussed herein may relate to running diagnostic tests to ensure product performance and reliability, creating new diagnostic tests using AI when new technologies or features are added, creating a product/client device history that can be used to glean insights into long term issues, and creating a more streamlined approach to helping the user with potential or existing problems. In addition, running self-diagnostics on a regular basis may help ensure proper performance and can potentially catch a problem before it becomes a major nuisance. But further note that in addition to or in lieu of regular diagnostic testing, the user may also work with a chatbot or other digital assistant after a problem has occurred, running diagnostics and executing AI-based fixes to the problem once it has occurred.

Then if there is a major problem, the diagnostics can supply more-detailed information to a support center. The client device experiencing the problem may thus automatically log a ticket with the support center to prevent the user from waiting on hold for long periods of time. Thus, by using self-diagnostics with AI ability, sensor fusion, and the ability to automatically connect to a support center to receive potentially faster and more efficient service, numerous technical advantages may be realized.

There are various methods that can be used to implement present principles. Non-limiting examples include, but are not limited to, having a hearable client device connect to another smart device to run diagnostics (e.g., manual operation with the other device executing the diagnostics on the hearable device to assess the hearable device over the wireless connection), having the hearable device run its own diagnostics without another smart device and then connecting to the other smart device to use the other device's Internet connection when there is a problem to report (e.g., partial manual and partial automated), having diagnostics be continually run in the background at the hearable and/or connected device and only reporting to the support center when requested or when there is a problem (e.g., fully automated), and/or having diagnostics be continually run in the background with results being frequently reported, logging results and history information. The frequency can be set by the user. Or the user can select a recommended default. And/or data may be sent when a local buffer is full (e.g., full buffer in RAM of the hearable device).

Further note that while hearable devices are discussed above and at various other points below, present principles may apply not just hearables but also to other types of client devices. Those client devices include, but are not limited to, televisions, soundbars, cameras, and more. And also note that while Wi-Fi and Bluetooth (e.g., Bluetooth Low Energy) wireless connections are sometimes discussed herein, present principles may also apply to other types of wireless connections as well, including low energy (LE) audio connections and ultrawideband (UWB) connections. Proprietary connections may also be used.

As for the hearables themselves, they may include hearing aids, ear buds, headphones, and other types of headsets with speakers and/or microphones for presenting audio to users.

Also note that cameras on a client device under test and/or connected client device may be used consistent with present principles. For example, the client device(s) may use the cameras to perform additional self-diagnostics, including identifying any flashing light-emitting diodes (LEDs) as well as their colors as might be illuminated on a housing of the client device under test (thus denoting an issue by LED flash frequency and/or LED color).

The cameras may also be used to identify juxtapositions of different client devices with respect to each other using computer vision. This might be useful in instances where the two devices are not wirelessly connected to each other to therefore infer that the devices are too far apart for wireless communication.

Cameras may also be used to identify device use in relation to a user, as might be the case with a hearable device or other headset consistent with present principles. Thus, computer vision may be used to determine whether the user is wearing the headset correctly and the AI can then make suggestions for better-fitting the hearable on the user's head for improved functionality.

### Support Center-Related Aspects

Next, present principles will be approached from the perspective of a consumer electronics technical support center device (e.g., one or more support center client devices and/or servers working individually or in conjunction with each other). Accordingly, various techniques may be used for auto-reporting client device diagnostics, logs, and history to the support center. When a deployed client device runs a self-diagnostic, it creates a report. That report may then be sent to the support center device for further action. The client device itself may thus run diagnostics and send information to be stored as history at the support center (e.g., no further user action required). In addition, the user may experience an error message or code and want to report it to the support center for help, which may then be recorded at the support center.

In one particular implementation, when AI executing at the support center receives data from a client device, the support center-side AI may parse the data and then decide if the issue flagged by the diagnostic needs immediate action. If immediate action should be taken, the support center AI may assign a ticket number to the issue. If there is a solution already, the support center AI may report the solution to the user and/or to the user's client device directly. But if there is action needed but no solution available, then the support center AI may assign the issue to a human resource for review and/or take other actions discussed below to autonomously come up with its own fix (e.g., have a large language model or other code generator generate a software fix for the client device). Also, if no immediate action is needed, then the data may be stored at the support center for historical analytics and trend identification. The support center AI may then review all data stored daily, weekly, monthly, and/or yearly for client device trends, as well as to prioritize issues that should be addressed.

In some examples, different geographical regions may have different regional AI support centers (e.g., different support centers for America, Europe, Asia, etc.). These regional support centers may contact each other and collaborate with each other to share data on trends, issues, solutions, workarounds, etc. Keeping in mind that some client devices may not be worldwide released client devices, or that worldwide-released client devices abide by a rollout plan over time (e.g., different release dates for different geographical regions), the support center AI(s) may keep track of which client devices are released to the public where and when.

What's more, the support centers may work together in a peer-to-peer embodiment in some examples. This may be done so that trends on client device issues may be identified by consensus among the distributed service center devices for different regions. Or in other examples, one service center may be the coordinator service center that receives trend data from the other service centers and identifies the trends and remedies itself to then report the remedies back to the other regional service centers.

For each client device to report an issue to the support center, it may use its own wireless connectivity to the Internet, or use another smart device that has Internet capability as a proxy if the device under test currently has no internet capability. The support center AI may then read the report(s) and decide which support group needs to be notified. The support center AI may also assign different levels of priority to different issues experienced by various client devices based on how many calls/reports are received for each issue (e.g., and dynamically update the priority ranking as necessary).

In some examples, the support center AI may also contact the user/client device for more information, contact the user/client device with a solution, and/or contact the user/client device for client device updates (e.g., new feature/functions, security, client device fixes, etc.).

In instances where info from the user is needed or wanted to augment the diagnostic report, the user may use a voice annotation feature to describe the problem, such as the way they were using the client device when the issue occurred. The voice annotation (e.g., LLM-based chatbot) may convert the audio file to text, and the user may even review the generated text before sending. Then when the support center receives the report, it may create an automatic ticket number and return the ticket number to the user. The support center AI may then read the report and decide which support department needs to address the issue while also assigning a priority level to the ticket/issue (e.g., low, mid, high).

In addition, the support center AI and/or human support technician may contact the user directly. This may be done to provide a workaround or a firmware update that is available to fix the problem. If necessary, the support center AI may gather more information about the problem. If desired, the support center AI and/or technician may activate the service mode of the client device to retrieve more-detailed information, log files, etc. The support AI may also connect directly to the client device to conduct more detailed diagnostics. Then if no immediate solution is available, the diagnostic information may be forwarded to the next level of help (e.g., Tier 1 or design). In addition, the support AI may keep track of all analytics regarding every contact (user/client device) made and create reports (e.g., Pareto charts) of all the active issues as well as issues that have already been solved. What's more, in some instances where appropriate, the support AI can overnight ship a replacement client device or part to the user and issue a return merchandise authorization (RMA) number for the user to send the defective client device back to the support center for analysis.

Thus, in various example implementations, the client device running the diagnostics may contact the support center directly with its diagnostic details. Additionally or alternatively, the support center AI may contact the client device directly, with the AI dynamically determining priorities for various product/device issues. This avoids the user having to call the support center and wait for help, while enabling the support center on a technical level to retrieve accurate details and determine if there is a solution or not. A support ticket may be automatically assigned in some instances, and the user may be contacted with a solution or to gather more information.

In addition, the support AI may save all the diagnostic data it receives to review that data regularly for trends. The support AI can also request further information from the client device and/or user, contact the user or client device with solutions/workarounds, and contact the user and/or client device with updates. What's more, the support AI may alert quality assurance devices and technicians at the manufacturer, as well as design centers (devices and/or real people) at the manufacturer, with trend analysis of growing problems. Trend data may also be used by product planning people for improving next-generation client device designs.

With the foregoing in mind, it is to be generally understood that this disclosure relates to aspects of consumer electronics (CE) devices and other types of client devices and servers. Thus, devices herein may include server and client components which may be connected over a network such that data may be exchanged between the client and server components. The client components may include one or more computing devices including mobile smart phones, smart watches and other mobile devices, wearable devices, game consoles, extended reality (XR) headsets such as virtual reality (VR) headsets and augmented reality (AR) headsets, display devices such as televisions (e.g., smart TVs, Internet-enabled TVs), personal computers such as laptops, desktop, and tablet computers, and still other types of devices. These client devices may operate with a variety of operating environments. For example, a client device consistent with present principles may employ, as examples, Linux and Unix operating systems, operating systems from Microsoft, or operating systems from Apple or Google. These operating environments may be used to execute one or more browsing programs, such as a browser made by Microsoft, Apple, Google, or Mozilla. The operating environments may also be used to execute other Internet-networked dedicated mobile applications that can access websites hosted by the Internet servers over a network such as the Internet, a local intranet, or a virtual private network.

Servers and/or gateways may be used that may include one or more processors executing instructions that configure the servers to receive and transmit data over a network such as the Internet. Or a client and server can be connected over a local intranet or a virtual private network. A server or controller may be instantiated by a personal computer, mobile device, rack or blade server, etc.

As indicated above, information may be exchanged over a network between client devices and servers. To this end and for security, servers and/or clients can include firewalls, load balancers, temporary storages, and proxies, and other network infrastructure for reliability and security.

As used herein, instructions may refer to computer-implemented steps for processing information in the system. Instructions can be implemented in software, firmware or hardware, or combinations thereof and include any type of programmed steps undertaken by components of the system.

A processor may be any single-or multi-chip processor that can execute logic by means of various lines such as address lines, data lines, and control lines and registers and shift registers. Moreover, any logical blocks, modules, and circuits described below can be implemented or performed with a processor/processor system such as a central processing unit (CPU), a digital signal processor (DSP), a field programmable gate array (FPGA) or other programmable logic device, an application specific integrated circuit (ASIC), discrete gate or transistor logic, discrete hardware components, or any combination thereof designed to perform the functions described herein. A processor can be implemented by a controller or state machine or a combination of computing devices.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

The functions and methods described below, when implemented in software, can be written in an appropriate language such as but not limited to hypertext markup language (HTML)-5, Java®/Javascript, C # or C++, and can be stored on or transmitted from a computer-readable storage medium such as a hard disk drive (HDD) or solid state drive (SSD), random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires.

In an example, a processor/processor system can access information over its input lines from data storage, such as a computer readable storage medium as referenced above, and/or the processor system can access information wirelessly from an Internet server by activating a wireless transceiver to send and receive data. Data typically is converted from analog signals to digital by circuitry between the antenna and the registers of the processor system when being received and from digital to analog when being transmitted. The processor system then processes the data through its shift registers to output calculated data on output lines, for presentation of the calculated data on the device, etc.

Components included in one embodiment can be used in other embodiments in any appropriate combination. For example, any of the various components described herein and/or depicted in the Figures may be combined, interchanged, or excluded from other embodiments. “A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

The term “a” or “an” in reference to an entity refers to one or more of that entity. As such, the terms “a” or “an”, “one or more”, and “at least one” can be used interchangeably herein.

The term “circuit” or “circuitry” may be used in the summary, description, and/or claims. The term “circuitry” includes all levels of available integration, e.g., from discrete logic circuits to the highest level of circuit integration such as VLSI, and includes programmable logic components programmed to perform the functions of an embodiment as well as processors (e.g., special-purpose processors) programmed with instructions to perform those functions.

### Figures

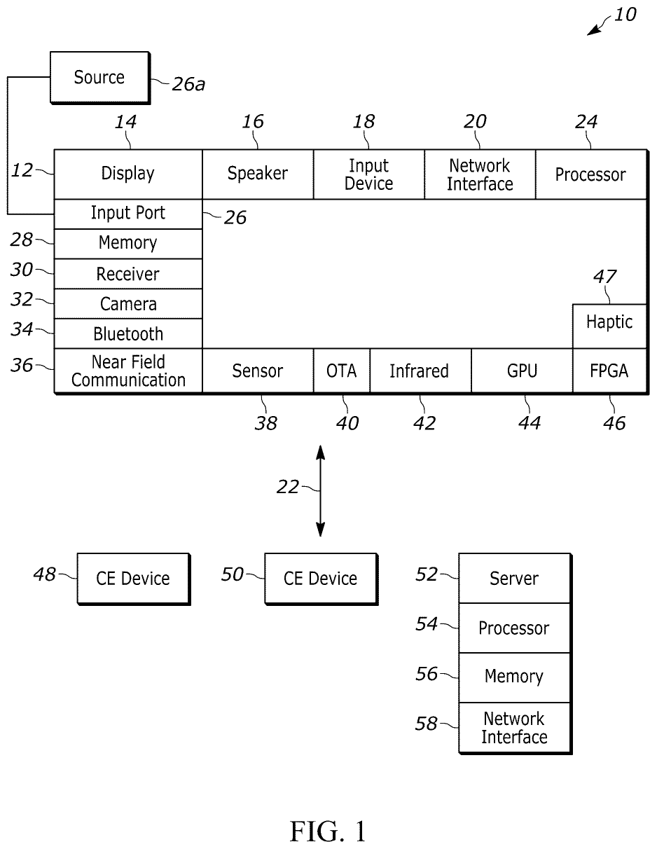

Referring now to FIG. 1, an example system 10 is shown, which may include one or more of the example devices mentioned above and described further below in accordance with present principles. The first of the example devices included in the system 10 is a consumer electronics (CE) device 12. The CE device 12 may be a computerized Internet enabled (“smart”) phone, a tablet computer, a laptop/notebook computer, a desktop computer, a head-mounted device (HMD) and/or headset such as smart glasses or AR or VR headset, another wearable computerized device, etc. Regardless, it is to be understood that the CE device 12 is configured to undertake present principles (e.g., communicate with other CE devices and servers to undertake present principles, execute the logic described herein, and perform other functions and/or operations described herein).

Accordingly, to undertake such principles the CE device 12 can be established by some, or all, of the components shown. For example, the CE device 12 can include one or more touch-enabled displays 14 that may be implemented by a high definition or ultra-high definition “4K” or higher flat screens. The touch-enabled display(s) 14 may include, for example, a capacitive or resistive touch sensing layer with a grid of electrodes for touch sensing consistent with present principles (e.g., to provide input to the GUIs discussed below).

The CE device 12 may also include an analog audio output port 15 to drive one or more external speakers or headphones, and may include one or more internal speakers 16 for outputting audio in accordance with present principles. The CE device 12 may also include at least one additional input device 18 such as one or more audio receiver/microphones, e.g., for detecting sound and entering audible commands to the CE device 12 to control the CE device 12. The example CE device 12 may also include one or more wired or wireless network interfaces 20 for communication over at least one network 22 such as the Internet, a WAN, a LAN, etc. under control of one or more processors of a processor system 24, such as a CPU or other processor mentioned above. Thus, the interface 20 may be, without limitation, a Wi-Fi transceiver and/or wireless telephony transceiver for communicating over a wireless cellular network (e.g., operated by Verizon, T-Mobile, or AT&T), both of which are examples of a wireless computer network interface. The network interface 20 may also be a wired or wireless modem or router or other suitable network interface.

It is to be understood that the processor system 24 may include one or more processors acting independently or in concert with each other to execute an algorithm, whether those processors are in one device or more than one device. The processor system 24 controls the CE device 12 to undertake present principles, including the other elements of the CE device 12 described herein such as controlling the display 14 to present images thereon and receiving input therefrom.

In addition to the foregoing, the CE device 12 may also include one or more input and/or output ports 26 such as a high-definition multimedia interface (HDMI) port or a universal serial bus (USB) port to physically connect to another CE device, and/or a headphone port to connect headphones to the CE device 12 for presentation of audio from the CE device 12 through the headphones. For example, the input port 26 may be connected wired or wirelessly to a cable or satellite source 26a of audio video content. Thus, the source 26a may be a separate or integrated set top box, or a satellite receiver. Or the source 26a may be a game console or disk player containing content.

The CE device 12 may further include one or more non-transitory computer memories/computer-readable storage media 28 such as disk-based or solid-state storage that are not transitory signals. In some cases, the media 28 may be embodied in the chassis/housing of the CE device 12 (e.g., as standalone devices) or as removable memory media or the below-described server(s).

Also, in some embodiments, the CE device 12 can include a position or location receiver such as but not limited to a cell phone transceiver, global positioning system (GPS) transceiver, and/or altimeter 30. This transceiver may therefore be configured to receive geographic position information from a satellite or cellphone base station (and/or determine an altitude at which the CE device 12 is disposed) and then provide the information to the processor system 24. However, it is to be understood that another suitable position receiver other than a GPS receiver, cell phone transceiver, and/or altimeter may be used consistent with present principles to determine the location of the CE device 12.

Continuing the description of the CE device 12, in some embodiments the CE device 12 may include one or more cameras 32 that may be thermal imaging cameras, digital cameras such as webcams, infrared (IR) sensors, and/or other types of cameras or other optical sensors integrated into the CE device 12 and controllable by the processor system 24 to gather pictures/images and/or video consistent with present principles. Also included on the CE device 12 may be a Bluetooth® transceiver 34 and/or other Near Field Communication (NFC) element 36 for communication with other devices using respective Bluetooth and/or NFC wireless technologies/communication standards. An example NFC element can be a radio frequency identification (RFID) element.

Further still, the CE device 12 may include one or more auxiliary sensors 38 that provide input to the processor system 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc.

Other sensor examples include a motion sensor such as an accelerometer, gyroscope, magnetometer, a speed and/or cadence sensor, an event-based sensor, a gesture sensor (e.g., for sensing gesture command), etc. In one specific example, the sensor 38 thus may be implemented as an inertial measurement unit (IMU) with motion sensors including individual accelerometers, gyroscopes, and magnetometers, and/or other components of that include a combination of accelerometers, gyroscopes, and magnetometers, to determine the location and orientation of the CE device 12 in three dimensions. A gyroscope consistent with present principles may sense and/or measure the orientation of the CE device 12 and provide related input to the processor system 24, an accelerometer consistent with present principles may sense acceleration and/or movement of the CE device 12 and provide related input to the processor system 24, and a magnetometer consistent with present principles may sense and/or measure directional movement of the CE device 12 and provide related input to the processor 122.

The CE device 12 may also include an over-the-air TV broadcast port 40 for receiving OTA TV broadcasts and providing the input to the processor system 24. In addition to the foregoing, it is noted that the CE device 12 may also include an IR transceiver 42 such as an IR data association (IRDA) device. A battery (not shown) may be provided for powering the CE device 12, as may a kinetic energy harvester that may turn kinetic energy into power to charge the battery and/or power the CE device 12. The CE device 12 may also be powered by an alternating current power supply. A graphics processing unit (GPU) 44 and field programmable gated array 46 also may be included.

One or more haptics/vibration generators 47 may also be provided for generating tactile signals/vibrations that can be sensed by a person holding or in contact with the device. The haptics generators 47 may thus vibrate all or part of the CE device 12 using an electric motor connected to an off-center and/or off-balanced weight via the motor's rotatable shaft so that the shaft may rotate under control of the motor (which in turn may be controlled by a processor such as the processor system 24) to create vibration of various frequencies and/or amplitudes as well as force simulations in various directions.

In addition to the CE device 12, the system 10 may include one or more other CE devices/types, which may include some or all of the components mentioned above in relation to the CE device 12. In one example, a second CE device 48 may be established by an Internet of things (IoT) device, a smartphone, a laptop computer, etc. A third CE device 50 is also shown in FIG. 1 and may include similar components as the other CE devices. Thus, in one example, the CE device 50 may be configured as a head-mounted display (HMD) that may include a heads-up transparent or non-transparent display for respectively presenting extended reality (XR) content such as AR content, VR, content, and/or mixed reality (MR) content. The XR content itself might include, as an example, one or more of the GUIs described below, presented stereoscopically. The HMD may be configured as a glasses-type display, or as goggle-type and/or VR-type display vended by various computer hardware manufacturers such as Apple, Oculus, Meta, etc.

In the example shown, only three CE devices are shown, it being understood that fewer or more devices may be used. A device herein may implement some or all of the components shown for the CE device 12. Any of the components shown in the following figures may incorporate some or all of the components shown in the case of the CE device 12.

Now in reference to the afore-mentioned at least one server 52, it includes at least one server processor/processor system 54 and at least one tangible computer readable storage medium 56 such as disk-based or solid-state storage. The server 52 also includes at least one network interface 58 that, under control of the server processor 54, allows for communication with other illustrated devices over the network 22 (e.g., the Internet), and indeed may facilitate communication between the server 52 and any other servers/client devices as described herein. Note that the network interface 58 may be, e.g., a wired or wireless modem or router, Wi-Fi or Ethernet transceiver, or other appropriate interface such as, e.g., a wireless telephony transceiver.

Accordingly, in some embodiments the server 52 may be an Internet server or an entire server “farm” of multiple services. If desired, the server 52 may include/perform “cloud” functions such that the devices of the system 10 may access a “cloud” environment via the server 52 in certain example embodiments. Additionally or alternatively, the server 52 may be implemented by one or more computers in the same room as the other devices shown, or nearby.

The components shown in the following figures may include some or all components shown herein. Any user interfaces (UI) described herein may be consolidated and/or expanded, and UI elements may be mixed and matched between UIs. UIs may be presented at a client device like the CE device 12 under control of the client device itself and/or under control of the server 52 as remotely controlling the CE device 12 to present the UIs thereon. Also note that selectors and options on the UIs discussed below may be selected via cursor input, touch input to a touch-enabled display on which the GUI is presented, using voice input, and/or using other input methods.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Attention-based architectures or transformer-based architectures may be used. Generative pre-trained transformers (GPT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network trained through machine learning may thus include an input layer, an output layer, and multiple hidden layers in between that are configured and weighted to make inferences about an appropriate output.

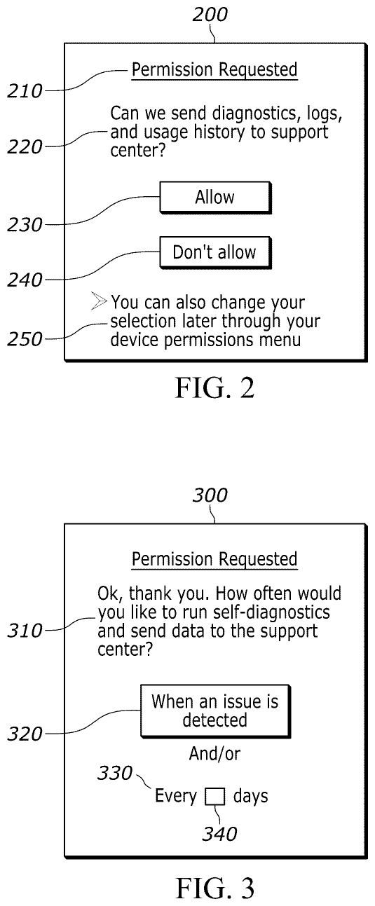

Now refer FIG. 2, bearing in mind the aforementioned relationship between a client device running its own AI and diagnostics and a support center-side device running its own AI. Suppose a first client device is being powered on for the first time subsequent to vending. If the first client device has its own display, the graphical user interface (GUI) 200 of FIG. 2 may be presented on that display. If it does not have its own display, as might be the case with a hearable device like headphones, the GUI 200 may be presented on the display of a paired smartphone or other client device with which the first client device is communicated (e.g., via a coordinating app executing at the other client device).

As shown in FIG. 2, the GUI 200 may include a prompt 210 that certain device permissions are being requested. The GUI 200 may also include text 220 asking whether the client device(s) can send diagnostic data, logs, and usage history to the support center. The user may then select the “allow” selector 230 to grant permission for the client device(s) to do so, or select the “don't allow” selector 240 to decline to grant such permission. Also note that additional text 250 may be presented to inform the end-user that the user can change the permission selection later through the device's permissions menu.

Assuming the “allow” selector 230 is selected from the GUI 200, the GUI 300 of FIG. 3 may then be presented in response. The GUI 300 may establish a follow-on permission screen where a prompt 310 may be presented asking the user how often the user would like the client device to run self-diagnostic testing and send the resulting data to the support center. The user may then select the selector 320 to provide input that the client device should do so when an issue is detected (e.g., responsive to an identified device error or malfunction). Additionally or alternatively, the user may use the setting 330 to specify, via a number entry box 340, a predefined interval of time at which the diagnostic testing should be done (e.g., even if no errors are detected) and resulting report sent to the support center.

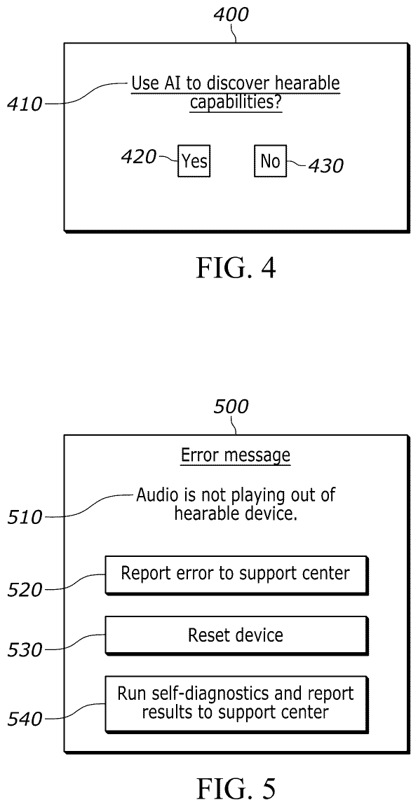

As another follow-on GUI or responsive to a firmware update (or other software update) occurring at a later time at the client device, the GUI 400 of FIG. 4 may be presented. As shown, a prompt 410 may be presented to ask the user whether the user wants to use local AI on the client device (and/or connected smart device) to discover the existing and/or new capabilities of the client device. In the present example, the client device is a hearable device. The user may then either select the “yes” selector 420 to command the client device to use the local AI, or select the “no” selector 430 to decline to do so.

Now suppose an error has occurred at the hearable device, whether that error is the device's software crashing, the hearable being unable to output audio via its speakers, the hearable being unable to receive an audio stream from the connected device, etc. In response to detecting the error, the GUI 500 of FIG. 5 may be presented. It may be appreciated that, in this example instance, the error message includes an indication 510 that audio is not playing out of the hearable device when it should. Based on this error, the user is given several choices of actions the client device might take.

Specifically, the user may select the selector 520 to command the client device to report the error itself to the support center. Selector 530 may be selected to command the client device to reset itself (e.g., restore factory default settings, do a factory reset, or simply restart). The selector 540 may be selected to command the client device to execute one or more self-diagnostic algorithms and report the results of the self-diagnostics to the support center. Note that in some examples the self-diagnostic algorithms may already exist and be stored at the client device for execution, while in other examples a local AI-based code generator may be used to generate the self-diagnostic algorithms that then gets executed at the client device.

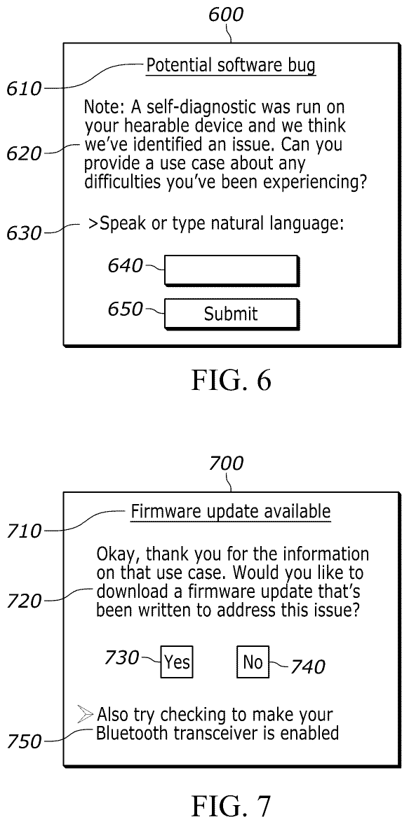

In either case, assume the self-diagnostic algorithm(s) that are run identify a potential software bug. The GUI 600 of FIG. 6 may include a prompt 610 indicating as much. The GUI 600 may also include a notification 620, which in the present example indicates that the self-diagnostic was executed on the hearable device and an issue has been identified. The notification 620 also requests that the user provide one or more use cases about any recent difficulties the user has experienced while trying to use the hearable device. The notification 620 may therefore be accompanied by a prompt 630 for the user to audibly speak natural language input about the use cases (e.g., as detected via a microphone on the hearable or connected device) or type natural language into the input box 640 using a hard or soft keyboard. Should the user choose to audibly speak the requested natural language, the audible input may be converted into text via speech-to-text software and then populated into the box 640 for further editing by the user if desired. The user may then select a “submit” selector 650 to submit the natural language presented in the box 640 to the service center along with the diagnostic result(s) themselves. At that point, the results may be analyzed by the service center AI and, if applicable, the service center device may then engage in further communications with the client device.

As one example, a firmware update may already exist to address whatever issue was identified by the self-diagnostics executed at the hearable client device, with the firmware update being written by an AI-based code generator without human intervention to thus solve the issue at hand. As such, the service center device may either push the firmware update to the hearable device for automatic download and installation (e.g., without user input or human other authorization). Additionally or alternatively, the service center device may transmit a notification to the hearable device that the firmware update is available. In response to receiving the notification, the GUI 700 of FIG. 7 may be presented at the client device to indicate the notification itself.

Accordingly, as shown in FIG. 7, the GUI 700 may include an indication 710 that “firmware update available”. The GUI 700 may also include text 720 acknowledging the additional input from the user to help identify the issue at the hearable device. In the present example, the text 720 indicates, “Okay, thank you for the information on that use case” The text 720 also asks the user, “Would you like to download a firmware update that's been written to address this issue?” The user may then select the “yes” selector 730 to command the client device to download and install the firmware update, or select the “no” selector 740 to command the client device to decline to do so. As also shown in FIG. 7, the GUI 700 may include a prompt 750 telling the user, “Also try checking to make sure your Bluetooth transceiver is enabled” at the hearable device to thus recommend another potential remedy to the issue detected by the diagnostic algorithm.

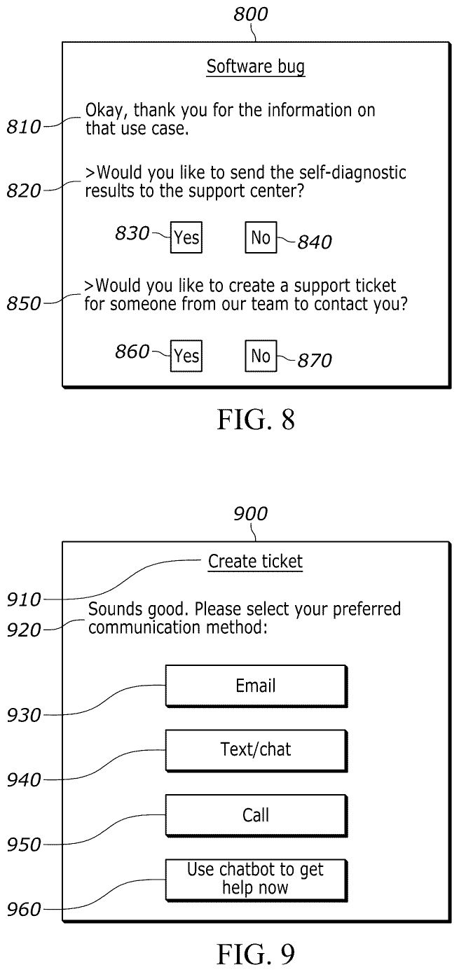

Now suppose the aforementioned firmware update does not already exist, or at the very least is unavailable for download. Based on this, the GUI 800 of FIG. 8 may be presented in lieu of the GUI 700. As shown in FIG. 8, the GUI 800 may include an acknowledgement 810 indicating that a software bug has been identified and further indicating, “Okay, thank you for the information on that use case.”

The GUI 800 may also include a prompt 820 asking the user if the user would like to send the self-diagnostic results to the support center. The user may then select the “yes” selector 830 to command the client device to send the results to the support center, or select the “no” selector 840 to command the client device to decline to do so. If the “yes” selector 830 is selected, the client device may then send the results to the support center for further analysis, trend tracking, etc.

The GUI 800 may further include a prompt 850 asking the user whether the user would like to create a support ticket for someone from the manufacturer's support team contact the user to help address the issue. The user may then select the “yes” selector 860 to command the client device to create the support ticket, or select the “no” selector 870 to command the client device to decline to do so. Assuming the user selects the “yes” selector 860, the follow-on GUI 900 of FIG. 9 may be presented in response.

As shown in FIG. 9, the GUI 900 may include an indication 910 that a support ticket is being created for the user's issue. The GUI 900 may also include text 920 indicating, “Sounds good, please select your preferred communication method” for the support center to then contact the end-user via the selected method. As such, the user may select a selector 930 to provide input for the user to be contacted via email, a selector 940 to provide input for the user to be contacted via text message or online chat, and a selector 950 to provide input for the user to be contacted via a telephone call.

In addition to receiving human help from a technician at the support center, the user can also elect to receive electronic help from a chatbot. As such, the selector 960 may be presented to launch a chat window where the user can exchange natural language messages with the chatbot (e.g., as backed by an LLM) to take the user through one or more steps in relation to the client device to try to solve the issue. But assuming the user does indeed wish to create a ticket and, as such, has selected one of the selectors 930-950, the ticket creation request may then be transmitted to the support center. The support center may then create the support ticket and send an acknowledgement notification back to the client device in response.

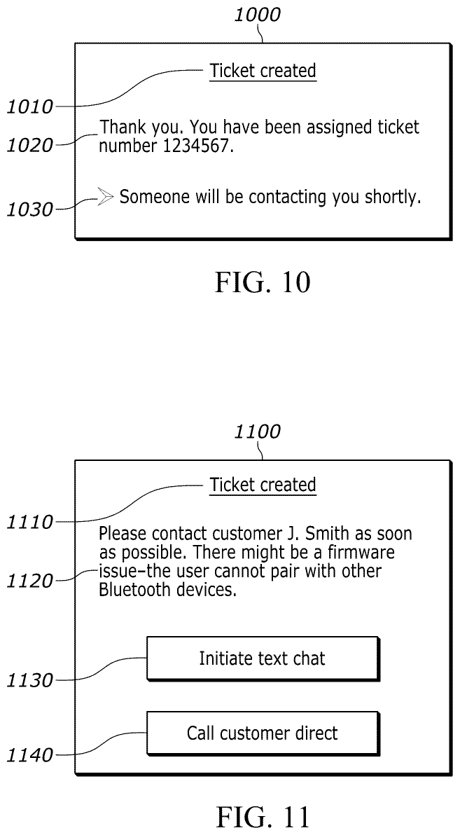

FIG. 10 therefore shows an example acknowledgement notification being presented as part of another GUI 1000 that replaces the GUI 900 on the client device display. As shown in FIG. 10, the GUI 1000 includes an acknowledgement 1010 that the ticket was created with the support center. The GUI 1000 may also include text 1020 providing the unique ticket number assigned to the user's case for the user's reference. In the present example, the text 1020 indicates, “Thank you. You have been assigned ticket number 1234567.” In some examples, the GUI 1000 may also include a note 1030 further informing the user that a person from the support center will be contacting the user shortly (via the user's preferred communication method specified via the GUI 900).

Continuing with the same example, attention is now directed to the functions of the support center device. Once the aforementioned ticket has been created, a notification may be presented on a display of the support center device in the form of the example GUI 1100 shown in FIG. 11. The GUI 1100 may include a notification 1110 to a support center technician that a ticket has been created for the end-user's issue. The GUI 1100 may also include natural language text 1120 generated by an LLM based on the diagnostic results from the diagnostic algorithm(s) executed at the client device, as well as any supplemental user input (e.g., like use cases specified by the user according to the example above). In the present example, the text 1120 indicates, “Please contact customer J. Smith as soon as possible. There might be a firmware issue—the user cannot pair with other Bluetooth devices.”

As also shown in FIG. 11, the GUI 1100 may include different ways in which the support technician may contact the user according to the user's selections of one or more of the selectors 930-950. Each method of communication selected via one of the selectors 930-950 may then be assigned to a respective selector presented on the GUI 1100 for the support technician to then select one of the potentially plural methods of communication preferred by the user. As such, in the present instance the GUI 1100 may include a selector 1130 to initiate an SMS or Internet-based text chat with the user, while the selector 1140 may be selected to initiate a telephone call between the support technician and the user.

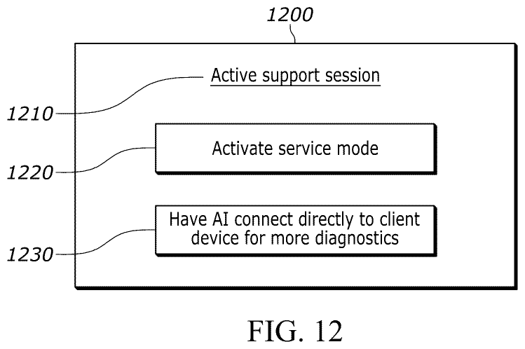

Now assume the support technician and user are communicating via the user's preferred method of communication. Responsive to the communication being established, the GUI 1200 of FIG. 12 may be presented. The GUI 1200 may therefore include a notification 1210 that an active support session is transpiring. The GUI 1200 may also be used to access one or more support center tools that can then be used to help the user address the issue (e.g., problem) experienced at the client device.

Accordingly, the support technician may select the selector 1220 to remote into the client device, with the support center client device being used by the support technician to remotely connect to the client device and use administrator access to control the client device itself from the remote support location. In the present example, the selector 1220 may be selected to not just remote into the client device, but to also activate a service mode of the client device for the support technician to have absolute control over the client device to help identify the problem (e.g., including being able to view otherwise encrypted log files, make modifications to client device kernel, and perform other sensitive actions at the client device). In some examples, another GUI may be presented at the client device itself for the end-user to select a selector granting such permission to the support center technician.

As another tool, the support center may have its own support center AI connect (remote in) to the user's client device directly to autonomously perform even more diagnostics using diagnostic algorithms executed by the support center device itself, which might be more powerful and have more features available that the relatively lighter diagnostic algorithms that may be able to be stored in the somewhat limited storage of the client device and executed by the relatively less-powerful client device processor. Accordingly, the selector 1230 may be selected to command the support center AI to remote into the client device and begin running its own diagnostics. Note that here too a GUI may be presented at the client device itself for the end-user to select a selector granting permission to the support center AI to run the diagnostics.

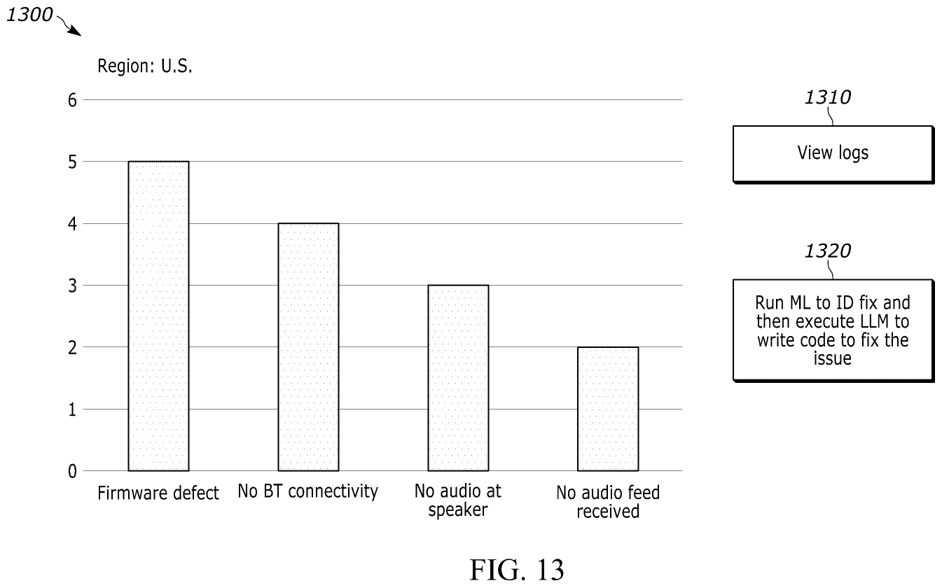

Turning to FIG. 13, this figure shows an example Pareto chart 1300 that might be presented on the display of a support center device responsive to a trigger. The trigger might be a command from a support center technician to view trends related to one type/model of client device provided by the manufacturer, or to view trends related to a group of different client devices provided by the manufacturer. Or the trigger may be a certain issue occurring at least a threshold number of times globally at all client devices reporting their diagnostics to the support center, or the issue occurring at least a threshold number of times in a particular geographic region (e.g., certain continent) at client devices in that region that are reporting their diagnostics to the support center. As another example of a trigger, the Pareto chart 1300 may be presented responsive to a recurring period of time ending so that someone from the support center regularly reviews trends related to one or more types or models of client devices at regular intervals. Also note in terms of client device model type that the model type might be a certain kind of client device generally (e.g., headphones, smartphone, etc.) or a particular sub-type released only to one geographic region while another, similar sub-type is released to another geographic region.

In any case, as may be appreciated from FIG. 13, the chart 1300 establishes a bar graph that visually represents client device issues in descending order left to right to highlight the most pronounced issues being experienced at client devices placed into the public by the manufacturer, with the chart 1300 visually demonstrating the frequency or impact of each issue. The Y axis of the chart 1300 therefore relates to total number of occurrences as multiplied by one hundred, while the X axis relates to different issues as individually identified by client device diagnostics consistent with present principles. Also note that in the present example, the trends shown in the chart 1300 are for client device issues reported within a single geographic region, in this case the United States (it being noted more generally that different geographic regions may also be established by country rather than continent).

As shown in FIG. 13, issues listed in descending order, left to right, for a hearable client device (e.g., ear buds or a hearing aid) include a firmware defect, no Bluetooth connectivity, no audio being emitted by the hearable's speaker, and no audio feed being received from another client device with which the hearable device is paired. The chart 1300 therefore allows the support technician to visualize the issues that are occurring across hearables of the same type and/or sub-type to identify which issue should be addressed first. Also note that should the technician and/or others associated with the manufacturer address the top issue (firmware defect) or top two issues (e.g., firmware defect, no Bluetooth connectivity) first, the other issues shown in the chart might resolve themselves and no longer be issues as the same underlying problem might be causing all four issues shown in the chart 1300 to be reported to the support center.

Also in terms of the chart 1300, though not shown for simplicity, note that in addition to the bars, the chart 1300 may also include a line graph increasing along the X axis to denote the cumulative total of all issues shown in the chart 1300 combined.

FIG. 13 also shows that the chart 1300 may not only be informational, but may also establish a GUI that is interactive. Thus, should the support technician wish to see the individual log files and/or diagnostic reports that were used by the support system to autonomously generate the chart 1300 itself (e.g., without support center technician input), the technician may select the “view logs” selector 1310 to do so.

In addition, the technician may select the selector 1320 to command the support center device (e.g., server/client device combination) to run a machine learning (ML) model to identify a solution (“fix”) to the top issue (or all issues listed in the chart 1300) and then execute a large language model (LLM) or other AI-based code generator to write code to solve/fix the issue(s). In the present example, the computer code may be a firmware update to the hearable device. Accordingly, selection of the selector 1320 may command the support center device to, responsive to that input, autonomously execute the ML model (which may include a pattern recognizer established by a feed-forward neural network or convolutional neural network as well as an ML solution inference component) and an LLM to work in tandem to generate a firmware update that can then be pushed or otherwise provided not just to the client devices already reporting the issues reflected in the chart but also all client devices in the same geographic region (or globally).

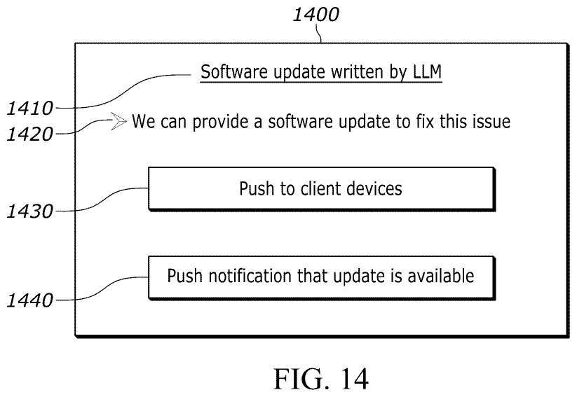

Responsive to the firmware update then being written by the AI (ML model and LLM as described above), the GUI 1400 of FIG. 14 may be presented on the display of the support center device. As shown, the GUI 1400 may include a notification 1410 that the software update has been written by the LLM. The GUI 1400 may also include a prompt 1420 that the software update can be provided to the client devices to address the issue(s) being reported. Accordingly, the support technician may select the selector 1420 to push the software update to the client devices, which may include remotely controlling the client devices from the support center device to download the software update to the client devices and then install the software update at each download device (e.g., assuming the end-user has enabled permissions for the support center to do so). Additionally or alternatively, the support technician may select the selector 1440 to command the support center device to push or otherwise provide a notification to the client devices that the software update is available for download and installation so that the end-users may do so at their own election. Thus, in some examples both selectors 1430, 1440 may be selected so that the software update is pushed to devices with download and install permissions enabled, while only a notification is sent to other devices that do not have those permissions enabled so that the software update can be downloaded at the end-user's election.

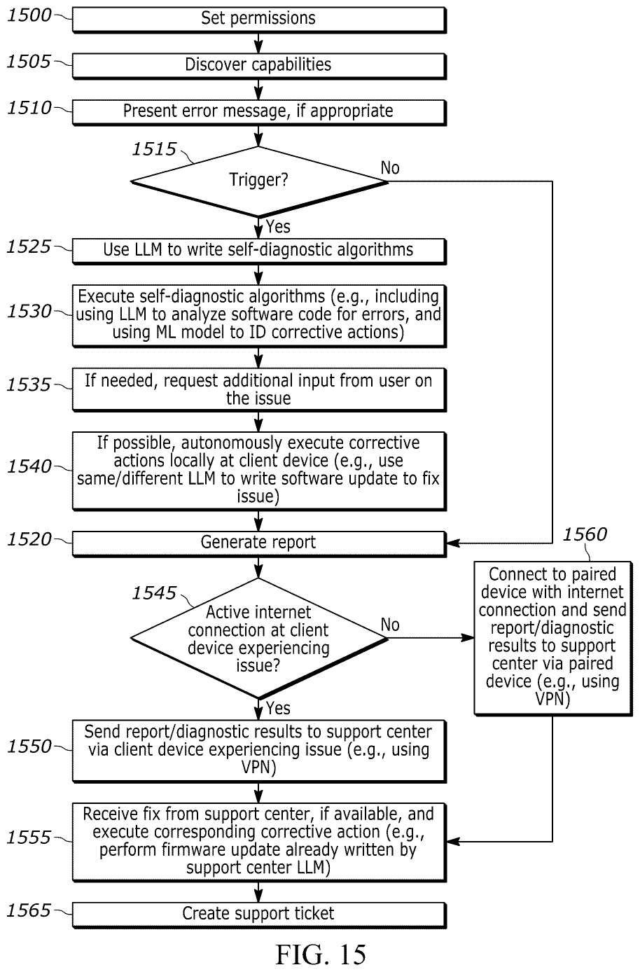

Continuing the detailed description in reference to FIG. 15, this figure shows example logic consistent with present principles that may be executed by one or more client devices alone or in any appropriate combination. For example, the logic of FIG. 15 may be executed by a hearable device alone, and/or may be executed in any appropriate combination by a hearable device and paired smartphone. Further note that while the logic of FIG. 15 is shown in flow chart format, other suitable logic may also be used.

Beginning at block 1500, the client device may set permissions for sending self-diagnostic data to a support center consistent with present principles. For example, at block 1500 permissions may be set consistent with the description of FIGS. 2 and 3 above. From block 1500 the logic may then proceed to block 1505.

At block 1505 the client device may use its on-board, local AI to discover capabilities of the client device. For example, at block 1505 the client device may discover capabilities consistent with the description of FIG. 4 and other aspects mentioned above.

After block 1505 the logic may proceed to block 1510. Here the client device may present an error message if appropriate (e.g., if an error has been detected as described above in reference to FIG. 5). The logic may then proceed from block 1510 to decision diamond 1515.

At diamond 1515 the logic may determine whether a trigger exists for executing one or more self-diagnostic algorithms at the client device to assess one or more aspects of the client device. In one example, the error message detected and then presented at block 1510 may be the trigger. Other triggers include, but are not limited to, a power-on of the device (e.g., a first power on after acquisition by an end-user), a new power cycle of the client device, a recurring period of time transpiring (e.g., such that the self-diagnostics are run every hour or day), and a software update being performed at the client device (e.g., firmware update, operating system update, individual software app update, etc.). The logic may proceed to block 1520 responsive to a negative determination at diamond 1515, or proceed to block 1525 responsive to an affirmative determination at diamond 1515.

At block 1520 the client device may generate a report, such as one regarding the underlying issue causing presentation of the error message at block 1510 (e.g., in embodiments where the error/message are themselves not triggers). Here, the report may be established as a data entry of the error into a local device log that lists recent device errors. Additionally or alternatively, the report may be sent to a support center device to indicate the identified error(s) to the support center device and, as such, the logic may proceed from block 1520 to decision diamond 1545 as will be described in a moment.

However, refer back to decision diamond 1515 and recall that an affirmative determination may cause the logic to proceed to block 1525. At this step the client device may determine if one or more self-diagnostic algorithms are already stored locally at the client device itself to perform self-diagnostics on the client device in general or to address whatever caused the trigger to be met (e.g., a firmware update related to a wireless transceiver). If so, the logic may proceed direct to block 1530. However, if a self-diagnostic algorithm does not already exist locally, the client device may either download the relevant self-diagnostic algorithm from the support center or write its own self-diagnostic algorithm locally using code generator software stored locally at the client device (and/or paired client device). The code generator may be established by LLM or other generative pretrained transformer (GPT), though other types of autonomous, generative code generators may also be used consistent with present principles.

Thus, suppose in one example instance that the trigger is a firmware update occurring at the client device. Responsive to determining as much at diamond 1515, the logic may proceed to block 1525 where the client device may, responsive to firmware being updated, execute an LLM to write/generate the one or more self-diagnostic algorithms to then analyze the updated firmware for identification of one or more errors in the updated firmware.

The logic of FIG. 15 may then proceed to block 1530 where the client device may therefore execute the existing, downloaded, and/or generated self-diagnostic algorithms to assess one or more aspects of the client device. So according to the example immediately above, at block 1530 the client device may execute the one or more self-diagnostic algorithms written by the LLM to analyze the updated firmware for identification of one or more errors in the updated firmware. Or as another example, the same or a different LLM may itself establish a self-diagnostic algorithm that can be executed locally by the client device's own processor system(s) (e.g., CPU) to analyze code stored at the client device to identify one or more errors in the code (e.g., firmware or other software).

Other AI models may also be executed at block 1530 as part of the client device's self-diagnostics. For example, at block 1530 the client device may, as part of execution of the one or more self-diagnostic algorithms, execute a ML model at the client device to assess one or more aspects of the client device and to identity, based on the assessment, one or more corrective actions to be performed at the client device. Or the ML model may be executed to identify corrective actions for issues identified by the LLM or other self-diagnostic algorithms that are also executed at block 1530 as part of the client device's self-diagnostics.

Note that the ML model itself may therefore be configured for pattern recognition and, as such, may include a feed-forward neural network and/or convolutional neural network for doing so. The ML model may also include a machine learning algorithm for inferring a corrective action to take to address an issue (e.g., error or malicious pattern).

From bock 1530 the logic may then proceed to block 1535 if needed, depending on whether the self-diagnostic algorithms identified one or more issues or were indeterminate in identifying at least one issue. Thus, at block 1535 the client device may request additional input from the user regarding whatever issue the user might be experiencing. For example, at block 1535 the client device might perform operations consistent with the description of FIG. 6 above.

From block 1535 the logic may then proceed to block 1540. At this step the client device may, if possible given its current software state, autonomously execute one or more corrective actions locally at the client device or, at the very least, perform the corrective actions in conjunction with the user input from block 1535 to assist in the corrective actions. Either way, the corrective actions may be performed at block 1540 without receiving input from a server or any other device that instigates performance of the corrective action(s).

Thus, in one particular example for block 1540, the client device may use the same or a different LLM as was used at blocks 1525 and/or 1530 to write a software update locally at the client device itself. The client device may then perform the software update it just wrote at the client device to fix or otherwise address whatever issue(s) were identified by the self-diagnostic algorithm(s). However, further note that still other AI models may be executed locally at the client device to address the issue(s) identified via the one or more diagnostic algorithms, including executing an ML model to take corrective action using the ML model itself.

From block 1540 the logic may then proceed to block 1520 to indicate one or more results of the self-diagnostic algorithms, and hence indicate one or more potential underlying errors, identified by the self-diagnostic algorithms (e.g., identified via the execution of the one or more self-diagnostic algorithms written by the LLM) in a report generated by the client device. The client device may then communicate with a server (e.g., support center server) to provide the report to the server and, if corrective actions have not already been taken locally at the client device itself, to determine one or more corrective actions to be performed at the client device to address the issue(s) indicated in the report.

Accordingly, from block 1520 the logic may proceed to decision diamond 1545. Here the client device may determine whether there exists a currently-active Internet connection at the client device that was experiencing the issue (the device under test). An affirmative determination at diamond 1545 may cause the logic to proceed to block 1550 where, responsive to an Internet connection being currently-active at the client device under test, the client device under test may use its own currently-active Internet connection to provide the report to the server. However, responsive to no currently-active Internet connection existing or being maintained at the client device under test, the logic may instead proceed to block 1560 where the client device under test may connect to a paired device (e.g., smartphone) that itself has an active Internet connection to provide the report to the server via the other client device with which the client device under test is communicating. Thus, the other client device (not under test) may be controlled to route communications from the client device under test to the server through the other client device to provide the report via the currently-active Internet connection at the other client device.

However, also note consistent with present principles that whether the client device under test or the other client device sends the report to the server, the client device providing the report to the server may first establish a virtual private network (VPN) in non-limiting embodiments to provide an added layer of digital security and anonymity. Thus, either client device may use the VPN to provide the report to the server.

From either of blocks 1550 or 1560 the logic may then proceed to block 1555. Here, if corrective action has not already been taken to address the issue (e.g., the client device lacks the capability to identify and perform the corrective action(s) itself), the client device may receive a fix from the support center device if available via the support center device, or otherwise receive AI-based assistance via the support center device to address the issue(s). Thus, also at block 1555, the client device may execute the corresponding corrective action according to the fix from the support center device.

As one example, the support center device might already have written its own firmware update to address the issue based on it identifying a trend of the issue occurring at a threshold number of client devices. So according to this example, the client device may download or otherwise receive the firmware update from the support center device and then execute the firmware update locally at the client device itself (the client device under test). In one particular instance, the firmware update may not have been written by human programmers but might instead have been written autonomously by a generative LLM executing at the support center device. This aspect will be described in greater detail later.

From block 1555 the logic may then proceed to block 1565. Here, if additional assistance is still needed to address whatever issue(s) was identified by the self-diagnostics that analyzed the client device under test, the client device may communicate with the server/support center device to create an electronic technical support ticket for a technician to use to help address the issue. So, for example, an end-user may use the GUIs of FIGS. 8 and 9 to create the electronic technical support ticket, and then a support technician may use the GUIs of FIGS. 11 and 12 consistent with the disclosure above to help address the issue. Also note here that the issue might relate not just to a firmware update or software execution, but also to wireless communication, to hardware device functionality, and/or to still other issues that might arise at the client device.

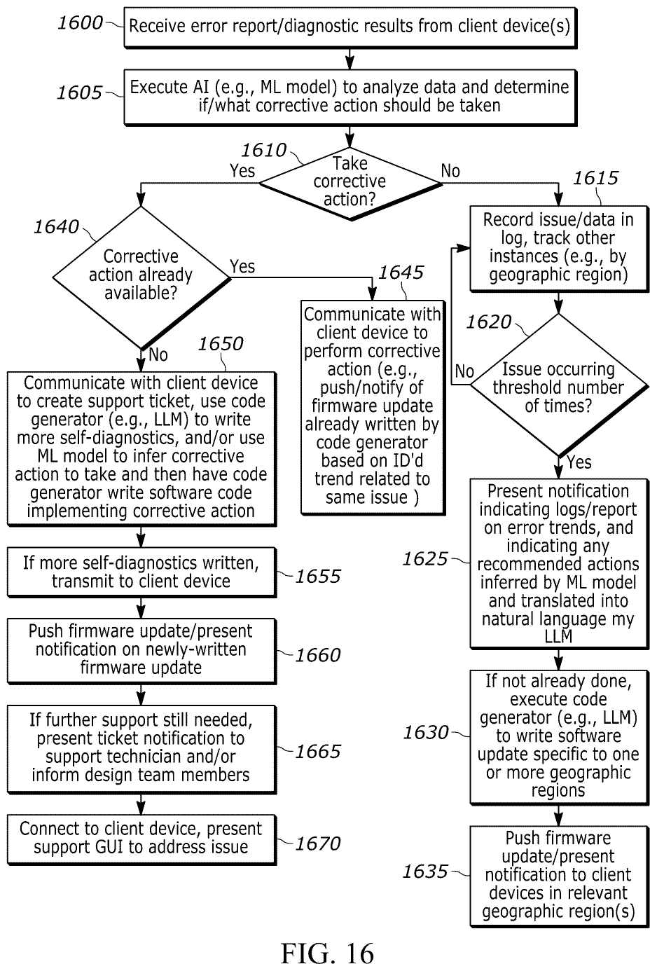

Now in reference to FIG. 16, this figure shows example logic consistent with present principles that may be executed by one or more consumer electronics technical support center devices alone or in any appropriate combination (e.g., including support center client devices and/or servers located in one or several geographic regions). Also note that while the logic of FIG. 16 is shown in flow chart format, other suitable logic may also be used.

Beginning at block 1600, the support center device may receive an error report and/or diagnostic report/results from one or more client devices. For example, at block 1600 the support center device may receive an error report sent at block 1520 or a self-diagnostic report sent at block 1550 from a client device as described above. From block 1600 the logic may then proceed to block 1605.

At block 1605 the support center device may execute one or more AI models to analyze the data received at block 1600 and to determine, based on the analysis, if/what corrective actions should be taken at the client device experiencing the issue to address the issue itself. For example, at block 1605 the support center device may execute an LLM and/or ML model to parse the data and determine whether corrective action should be taken.

Accordingly, the actual determination of whether to take the corrective action may be performed at decision diamond 1610. A negative determination at diamond 1610 may cause the logic to proceed to block 1615, while an affirmative determination at diamond 1610 may instead cause the logic to proceed to decision diamond 1640 as will be described in a moment. But for now, assume the support center device determines to not take corrective action and therefore moves to block 1615.

The support center device might determine to not take corrective action for a variety of reasons. For example, this may be the first time the support center device has encountered the issue reported by the client device under test and the support center device does not currently have a firmware update to fix it. Or even if the support center device has AI capabilities as will be described in greater detail below, the support center device may be set to only use those AI capabilities to take corrective action responsive to the issue being reported a threshold amount of times so as to minimize processor constraints and energy consumption that would ensue by running AI models to fix what might otherwise be a one-off problem encountered only by one or a handful of client devices (under the threshold amount).

Accordingly, at block 1615 the support center device may, responsive to determining that corrective action should not be taken, record the reported issue(s) in a log maintained/stored at the support center device and then track other instances of the issue occurring at other client devices besides that particular client device (e.g., across the globe, and/or through tracking by specific geographic regions). The logic may then proceed to decision diamond 1620 where the support center device may determine whether the issue has occurred at least a threshold amount of times at client devices globally and/or within a particular geographic region. Responsive to a negative determination at diamond 1620, the logic may revert back to block 1615 to continue tracking the instances of the issue occurring at different client devices until such time as an affirmative determination is made at diamond 1620.

Then, responsive to determining that the issue has occurred at least the threshold amount of times at client devices, the support center device may move to block 1625. At this step, the support center device may present a notification on a display accessible to the support center device. The notification may indicate self-diagnostic logs and/or reports on error/issue trends experienced at the reporting client devices.

The notification may also indicate a recommended action to take to address the issue, where the recommended action might be inferred by an ML model consistent with present principles. For example, the notification presented at block 1625 may be established by the chart 1300 with interactive selectors shown in FIG. 13. Thus, in one particular example at block 1625, the support center device may input into an LLM the recommended action (e.g., write a software update to apply) as inferred by the ML model based on its own parsing of the data to infer the recommended action to remediate the issue. The support center device may also input the diagnostic reports themselves as input to the LLM for the LLM to use that diagnostic data to locate the software defect in the code and then write an update to fix the defect.

The support center device may also execute the LLM to generate natural language indicating the ML-inferred recommended action to then include in the notification shown on the face of the selector 1320 described above. Again note that the recommended action indicated on the face of the selector 1320 includes executing an LLM to write software code to be installed at the client devices experiencing the issue to fix the issue itself. Thus, in one particular instance responsive to executing the ML model to infer the software update to apply at the client devices, the support center device may proceed to block 1630 to execute a code generator (e.g., same or different LLM) to write the software update itself.

The logic may then proceed to block 1635 where the support center device may push the generated code (e.g., a firmware update) to the client devices that reported the issue and even to client devices that did not. Additionally or alternatively but still at block 1635, the support center device may communicate with the client devices that reported the issue, and even the ones that did not, to present a notification at those client devices that the generative software update as written autonomously by the code generator is available. Thus, in one particular instance at block 1635, the support center device may communicate with the client device(s) to present the GUI 700 of FIG. 7.

Consistent with the disclosure above, it is reiterated that the support center device may track, by geographic region, instances of the issue occurring at different client devices. So in certain examples based on determining that the issue has occurred at least the threshold amount of times at client devices in a first geographic region (e.g., the U.S.), the support center device may communicate with client devices in a second geographic region (e.g., Europe) to take the corrective action at the client devices in the second geographic region. Thus, the support center device may execute an LLM to write a firmware update to address the issue as occurring at the client devices in the second geographic region, with the firmware update as written by the LLM containing code that is specific to the client devices in the second geographic region and that is inapplicable to client devices in the first geographic region. This may be done based on the recognition that a certain model of client device might have different sub-models released in geographic regions for a variety of reasons such as different wireless standards, different privacy practices, different network infrastructure, etc. The firmware update may then be pushed to the client devices in the second geographic region, and/or the support center device may transmit notifications to the client devices in the second geographic region that the firmware update is available.

Now refer back to decision diamond 1610 in terms of the decision regarding whether a corrective action should be taken, and recall that an affirmative determination at that step may instead cause the logic to proceed to decision diamond 1640. At diamond 1640 the support center device may determine whether a corrective action that should be taken is already available. For instance, a firmware update might already be written by a code generator as described herein to address the issue indicated via the diagnostic test data reported by a given client device, but the firmware update has not yet been pushed to client devices that have not experienced the issue and instead is made available once a given client device does in fact report the same issue the firmware update has already been designed to fix. Thus, an affirmative determination at diamond 1640 may cause the logic to proceed to block 1645 where the support center device may communicate with the reporting client device to perform the corrective action. Using the firmware update example immediately above, this may include pushing the firmware update to the reporting device, and/or presenting a notification at the reporting client device that a firmware update has already been written by the code generator based on the identified trend related to the same issue (as reported by other client devices) and is therefore available for installation at the reporting client device in this instance.

Referring back to decision diamond 1640, now assume instead that a negative determination is made at this step. Here the logic may instead move to block 1650 where, responsive to determining that corrective action should be taken but one is not already available, the support center device may create an electronic technical support ticket for a technician to help address the issue consistent with the disclosure above. Also at block 1650, the support center device may inform a design team member(s) (hardware and/or software) so further action can be taken as appropriate.

In addition to or in lieu of that but also at block 1650, if the support center device has not yet determined what corrective action should be taken but just that one should in fact be taken, the support center device may execute an LLM or other code generator to write the one or more self-diagnostic algorithms. This may be done responsive to receiving, from the reporting client device, the indication that the issue has occurred (e.g., received at block 1600). Note that the support center-based code generator may be used to write more-robust and comprehensive self-diagnostic algorithms than what the client device itself might be capable of writing using a thinner LLM given the client device's relatively more-limited processing and storage ability compared to the server that the support center might be using to execute the support center-side code generator.

Also at block 1650 and also if the support center device has not yet determined what corrective action should be taken but just that one should in fact be taken, the support center device may execute one or more ML models to infer a corrective action to take to address the issue at the client device. Then here too the support center device may execute a code generator to write software code that is executable by the first device to implement the corrective action at the client device itself. The code generator may be the same or different from the one in the paragraph immediately above, but in either case may also be established by an LLM in non-limiting examples.

From block 1650 the logic may then continue to block 1655. At this step the support center device may transmit, to the client device, any self-diagnostic algorithms written by the LLM at block 1650 for execution by the client device. Then at step 1660 the support center device may push any firmware update written at block 1650, or at least send a notification about the newly-written firmware update to the client device, similar to the process described in reference to block 1645.

The logic may then proceed to block 1665 where, if further support is needed, the support center device may present a ticket creation/existence notification on a display of the support center device for viewing by a support center technician. For example, at block 1665 the support center device may present the GUIs of FIGS. 11 and/or 12. Also note that further support might be needed if, for example, the ML model fails to infer what particular corrective action should be taken for what is a new issue or an issue that is unique to the client device under test. Thus, at block 1670 the support center device may connect to the client device and present a support center GUI (e.g., the GUI 1200) to allow the support center technician to help the end-user of the client device address the issue. For example, at block 1670 the support center device might remote into the client device consistent with the disclosure above.

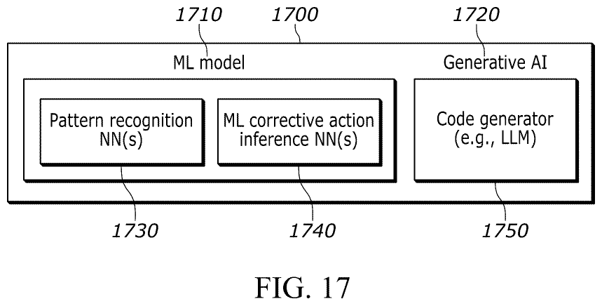

Continuing the detailed description in reference to FIG. 17, this figure shows example AI model architecture that may be implemented consistent with present principles. For example, the AI architecture for FIG. 17 may be implemented at a client device consistent with present principles. Additionally or alternatively, the AI architecture may be implemented at a support center device also consistent with present principles.

As shown in FIG. 17, an overall AI model 1700 may include an ML model 1710 and generative AI 1720. The ML model 1710 may include one or more pattern recognition neural networks (NNs) 1730 for recognizing patterns in diagnostic data from a single client device under test, and/or for recognizing patterns in diagnostic data across client devices globally (or within a particular geographic region) based on diagnostic test reports sent by the various client devices. The NNs 1730 may be established by feed-forward NNs, convolutional NNs, and/or other AI models also trained for pattern recognition.

As also shown in FIG. 17, the ML model 1710 may include one or more ML corrective action inference NNs 1740. The NNs 1740 may be configured to take pattern inferences provided by the NNs 1730, and/or take as input other diagnostic test data received from self-diagnostic algorithms that have been executed, to then infer a corrective action to take in response. The NNs 1740 may therefore be established by one or more regression ML models, such as one or more linear regression models, generalized linear models, Gaussian progress regression models, and/or still other types of ML models.

Corrective actions inferred by the NNs 1740 may then be provided as input to a code generator 1750 that establishes some or all of the generative AI 1720. Again note that the code generator may be an LLM or other suitable autonomous, generative computer code writer. The code generator 1750 may be trained to generate computer code in a variety of different code formats, such as Javascript, C++, Python, etc. The code generator 1750 may therefore be configured to write firmware updates, software code for individual apps executable at client devices, operating system updates (e.g., native and guest), and still other computer code to implement a corrective action inferred by the NNs 1740. The generator 1750 may then output the code as a software/firmware update or other code that is then executable at a client device to implement the corrective action.

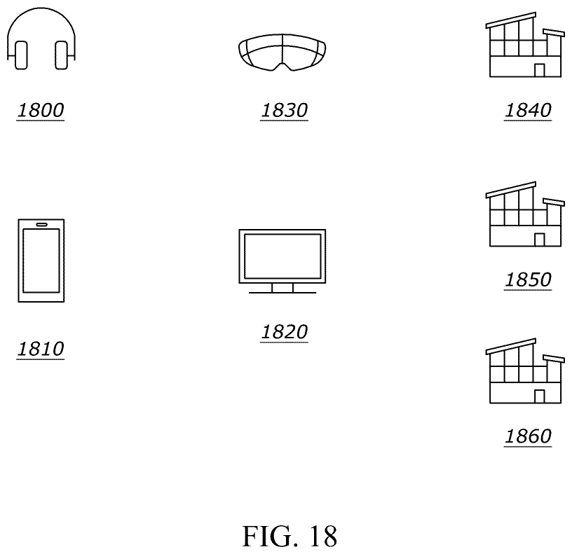

Now in reference to FIG. 18, an example overall system of client devices and support center devices is shown that may be implemented consistent with present principles. All of the devices shown in this figure may have network connectivity and, as such, may communicate with each other as set forth above (e.g., using the Internet). As shown in this figure, the system may include a hearable device 1800 (headphones in this example), a smart device 1810 (a smartphone in this example), and a television 1820 that has a camera (not shown for simplicity). The system may also include an extended reality (XR) device 1830 such as an augmented reality headset (with transparent display) or virtual reality headset (non-transparent display).

As also shown in FIG. 18, the system may include a first support center/device 1840 for a first geographical region, a second support center/device 1850 for a second geographical region, and even a third (uber) support center device 1860.

Note that FIG. 18 is but an example and that other combinations of client devices and support center devices may also be implemented consistent with the description above.

Before concluding, it is to be understood that although a software application for undertaking present principles may be vended with a device, present principles apply in instances where such an application is downloaded from a server to a device over a network such as the Internet. Furthermore, present principles apply in instances where such an application is included on a computer readable storage medium that is vended and/or provided by itself, where the computer readable storage medium is not a transitory signal and/or a signal per se.

It may now be appreciated that present principles provide, among other technical improvements, improved computer-based user interfaces that increase the functionality and ease of use of the devices disclosed herein. The disclosed concepts are rooted in computer technology for computers to carry out their functions.

It is to be understood that whilst present principles have been described with reference to some example embodiments, these are not intended to be limiting, and that various alternative arrangements may be used to implement the subject matter claimed herein.

What is claimed is:

1. A first client device, comprising:
a processor system; and
storage accessible to the processor system and comprising instructions executable by the processor system to:
responsive to a trigger, execute one or more self-diagnostic algorithms at a second client device to assess one or more aspects of the second client device;
based on execution of the one or more self-diagnostic algorithms, generate a report indicating one or more results of the one or more self-diagnostic algorithms;
communicate with a server to provide the report to the server and to determine one or more corrective actions to be performed at the second client device to address an issue indicated in the report; and
perform the one or more corrective actions to address the issue.

2. The first client device of claim 1, wherein the instructions are executable to:
as part of execution of the one or more self-diagnostic algorithms, execute a large language model (LLM) to analyze code stored at the second client device to identify one or more errors in the code; and
indicate the one or more identified errors in the report.

3. The first client device of claim 2, wherein the code comprises firmware code.

4. The first client device of claim 1, wherein the instructions are executable to:
responsive to firmware being updated at the second client device, execute a large language model (LLM) to write the one or more self-diagnostic algorithms to analyze the updated firmware for identification of one or more errors in the updated firmware;
execute the one or more self-diagnostic algorithms written by the LLM to analyze the updated firmware for identification of one or more errors in the updated firmware; and
indicate, in the report, a first error identified via the execution of the one or more self-diagnostic algorithms written by the LLM.

5. The first client device of claim 1, wherein the one or more corrective actions are one or more first corrective actions, and wherein the instructions are executable to:
as part of execution of the one or more self-diagnostic algorithms, execute a machine learning (ML) model at the second client device to assess one or more aspects of the second client device and to identity, based on the assessment, one or more second corrective actions to be performed at the second client device; and
perform the one or more second corrective actions at the second client device without receiving input from the server instigating performance of the one or more second corrective actions.

6. The first client device of claim 1, wherein the instructions are executable to:
communicate with the server to create an electronic technical support ticket for a technician to use to help address the issue.

7. The first client device of claim 1, wherein the one or more corrective actions are autonomously performed by the second client device.

8. The first client device of claim 1, wherein the one or more corrective actions are performed in conjunction with user input to assist in the one or more corrective actions.

9. The first client device of claim 1, wherein the second client device is the first client device.

10. The first client device of claim 9, wherein the instructions are executable to:
responsive to an Internet connection being currently-active at the first device, use the currently-active Internet connection to provide the report to the server; and
responsive to no currently-active Internet connection at the first device, communicate with a third client device to provide the report to the server via the third client device, the third client device being different from the first client device.

11. The first client device of claim 1, wherein the second client device is different from the first client device, and wherein the instructions are executable to:
route communications from the second client device to the server through the first client device to provide the report via a currently-active Internet connection at the first client device.

12. The first client device of claim 11, wherein the instructions are executable to:
establish a virtual private network (VPN) at the first client device; and
use the VPN to route the communications from the second client device to the server.

13. The first client device of claim 1, wherein the issue relates to one or more of:
wireless communication, hardware device functionality, software execution.

14. The first client device of claim 1, wherein the trigger comprises one or more of:
power-on of the second client device, a new power cycle of the second client device, a recurring period of time transpiring, a software update being performed at the second client device.

15. A method, comprising:
executing one or more diagnostic algorithms at a client device to assess one or more aspects of the client device;
based on executing the one or more diagnostic algorithms at the client device, one or more of:
executing an artificial intelligence (AI) model to address an issue identified via the one or more diagnostic algorithms; and/or
generating a report indicating the issue and sending the report to a support center for assistance in addressing the issue identified via the one or more diagnostic algorithms.

16. The method of claim 15, comprising:
based on executing the one or more diagnostic algorithms at the client device, executing the AI model to address the issue identified via the one or more diagnostic algorithms

17. The method of claim 15, comprising:
based on executing the one or more diagnostic algorithms at the client device, generating the report indicating the issue and sending the report to the support center for assistance in addressing the issue identified via the one or more diagnostic algorithms.

18. An apparatus, comprising:
at least one computer readable storage medium (CRSM) that is not a transitory signal, the at least one CRSM comprising instructions executable by a processor system to:
execute one or more diagnostic algorithms at a client device to assess one or more aspects of the client device;
based on execution of the one or more diagnostic algorithms at the client device, one or more of:
execute a model locally at the client device to address an issue identified via the one or more diagnostic algorithms; and/or
generate a report indicating the issue and send the report to a server for artificial intelligence-based assistance via the server to address the issue.

19. The apparatus of claim 18, wherein the instructions are executable to:
based on execution of the one or more diagnostic algorithms at the client device, execute the model locally at the client device to address the issue.

20. The apparatus of claim 18, wherein the instructions are executable to:
based on execution of the one or more diagnostic algorithms at the client device, generate the report indicating the issue and send the report to the server for artificial intelligence-based assistance via the server to address the issue; and
communicate with the server, in response to sending the report, to address the issue.
